(19) United States
(12) Patent Application Publication
(10) Pub. No.: US 2007/0123077 A1
(43) Pub. Date: May 31, 2007

(54) ELECTRICAL CONNECTION

(75) Inventor: George J. Franks JR., Inverness, IL (US)

Correspondence Address: BELL, BOYD & LLOYD, LLP, P.O. Box 1135, CHICAGO, IL, 60690, US

(73) Assignee: Senior Industries, Inc., Wood Dale, IL (US)

(21) Appl. No.: 11/668,964

(22) Filed: Jan. 30, 2007

Related U.S. Application Data
(63) Continuation of application No. 10/785,917, filed on Feb. 24, 2004, now abandoned.

(51) Int. Cl. H01R 13/62

(52) U.S. Cl. 439/157

(57) ABSTRACT

An electrical connection is provided for connecting electrically transmitting cables and/or wires to one another or any other component in a manner that provides an environmentally sealed connection. The electrical connection includes an electrical connector for connecting electrical cables or wires that includes seals which are disposed in grooves in the threaded portions of the electrical connector. The electrical connector may also include a second set of grooves separated from the first set of grooves, in order to cause moisture and other debris to migrate away from the seals. When the end connectors of electrical cables or wires are connected to the electrical connector, the interior threads of end connectors cover and deform the surface of the seals to create an enhanced seal between the connector and the end connectors. Thus, the electrical connector effectively seals the interface between the connector and the end connectors of electrical cables or wires, such that moisture and other debris are prevented and/or substantially deterred from migrating into the interior of the cable or wire.

### PRIORITY CLAIM

This application claims priority to and the benefit as a continuation application of U.S. patent application entitled “Electrical Connection,” Ser. No. 10/785,917, filed Feb. 24, 2004.

### BACKGROUND

The present invention is directed to an electrical connection and, more particularly, to a connection for connecting electrically transmitting cables and/ or wires to one another or other components in a manner that provides an environmentally sealed connection.

### SUMMARY

Electrical signal-type distribution cables or wires are used to deliver data transmission services, such as those for telecommunications, cable television and internet, to commercial and residential buildings. These distribution systems are located outside of the buildings and do not directly enter the structures. Rather, the buildings include an internally wired system to distribute the electrical signal or transmission throughout the structure. Thus, there generally is an interconnection between the distribution system bringing the service to the buildings and the internal wiring which transmits the service into and throughout the buildings. Often, this interconnection is outside of the building and, therefore, is exposed to the elements, such as rain, snow, and other forms of moisture and foreign debris.

Likewise, electrical signal-type cables or wires are used to distribute services throughout the interior of commercial and residential buildings. These internal wiring systems often involve interconnections between lengths of cable and other components using electrical connectors, such as splices or splitters, as well as other similar hardware. In some cases, the interconnections may be exposed to high levels of moisture, such as high levels of humidity in buildings located in humid climates or in a basement of a building, and/or foreign debris, such as high levels of dust which maybe present in a workshop or similar location. Therefore, under certain circumstances the internal wiring of a building also may be exposed to conditions that would benefit from an environmentally sealed connection.

When the interconnection between the ends of two cables, such as coaxial cable from a service distribution system and a coaxial cable running through the interior of a structure, is located on the outside of the structure or in certain areas within a structure, moisture or other foreign debris, such as dirt or dust, can migrate into the connection and the interior of the cables through the cable connection at an electrical connector, such as an F-connector. The migration of moisture and other debris into the connection and/or the interior of the cables is found to interfere with the integrity of the signal. This interference results from a deterioration of the cable and connector component and the electrical contact between such components.

Prior art electrical connectors have attempted to prevent the migration of moisture and other debris into the connection and the interior of the cables by mounting an o-ring at the ends of the threads of the connector (i.e., against the hexagonal flange of the connector), such that the end connector was intended to form a seal by pressing the o-ring against the flange when it was tightened onto the electrical connector. However, due to manufacturing variations of both the electrical connectors and the end connectors of the electrical cables and wires, the end connector often “bottoms out” before coming into contact with the o-ring or before pressing the o-ring sufficiently against the flange to form an effective seal, Thus, the end connector could not be tightened onto the electrical connector a distance sufficient to use the o-ring to form an environmental seal. In such cases, therefore, the connection between the end connectors of the cables or wires and the electrical connectors was not environmentally sealed and moisture and other debris was free to migrate into the interior of the connection and of the cables or wires, and the interference discussed above was not prevented.

Additional features and advantages are described herein, and will be apparent from, the following Detailed Description and the figures.

### BRIEF DESCRIPTION OF THE FIGURES

FIG. 1 is an exploded perspective view of an electrical connector according to any new design;

FIG. 2 is a elevational view of the electrical connector of FIG. 1 without the o-rings;

FIG. 3 is an elevational view of the electrical connector of FIG. 1, including a cross-sectional view of the o-rings mounted on the electrical connector;

FIG. 4 is an elevational view of the electrical connector of FIG. 1, including a cross-sectional view of the o-rings mounted on the electrical connector and ends of coaxial cables attached to the electrical connector;

FIG. 5 is an elevational view of the electrical connector of FIG. 1, including a cross-sectional view of the o-rings mounted on the electrical connector and ends of coaxial cables attached to the electrical connector;

FIG. 6 is an enlarged elevational partial view of the electrical connector of FIG. 1, showing the inner thread/o-ring/end connector interface of FIG. 5;

FIG. 7 is an exploded perspective view of another embodiment of an electrical connector embodying features of the present invention;

FIG. 8 is a elevational view of the electrical connector of FIG. 7 without the o-rings;

FIG. 9 is an elevational view of the electrical connector of FIG. 7, including a cross-sectional view of the o-rings mounted on the electrical connector;

FIG. 10 is an elevational view of the electrical connector of FIG. 7, including a cross-sectional view of the o-rings mounted on the electrical connector and ends of coaxial cables attached to the electrical connector; and

FIG. 11 is a plan view of another embodiment of an electrical connector embodying features of the present invention.

### DETAILED DESCRIPTION

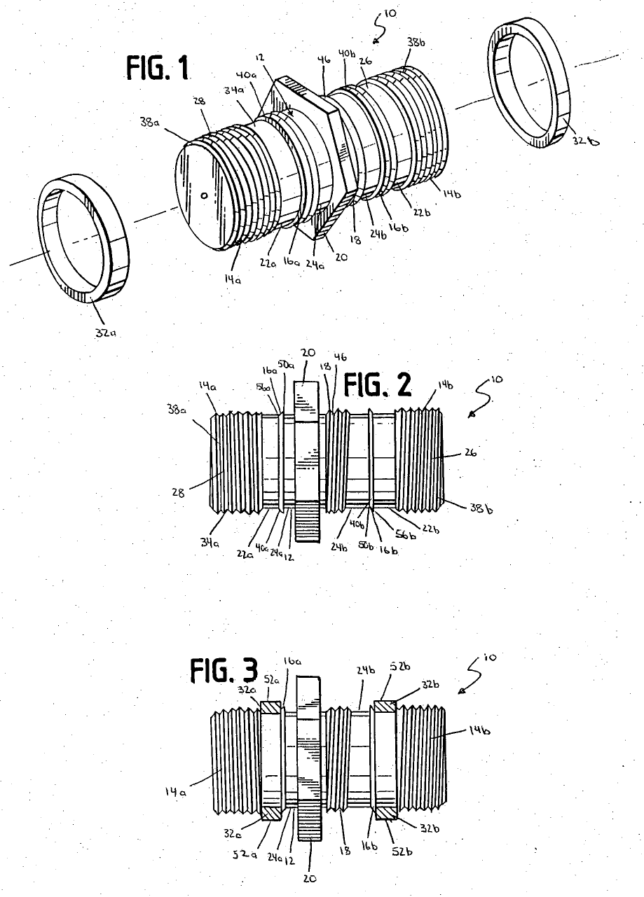

Referring to FIGS. 1-4, there is illustrated an electrical connector 10 having a body 12. The body 12 includes outer threaded portions 14a, 14b and inner threaded portions 16a, 16b, which are separated by outer grooves 22a, 22b. Seal members, such as o-rings 32a, 32b, are disposed in the outer grooves 22a, 22b. The body 12 also includes inner grooves 24a, 24b. When cable or end connectors 42a, 42b of electrical cables 48a, 48b are connected to the electrical connector 10, interior threads 44a, 44b of end connectors 42a, 42b cover and deform the surfaces of the seal members and create a seal between the electrical connector 10 and the end connectors 42a, 42b. The outer grooves 22a, 22b and the seal members are sized and axially located such that the electrical connector 10 provides an effective seal between the electrical connector 10 and the end connectors 42a, 42b of electrical cables or wires, regardless of the length of the end connectors 42a, 42b, such that moisture and other debris are substantially prevented from migrating into the interior of the cable. Thus, the electrical connector 10 provides a universal-type seal arrangement to accommodate varying sized end connectors of cables and wires.

The body 12 includes a hexagonal flange 20 separating a first cylindrical portion 34a and a second cylindrical portion 34b. The two cylindrical portions 34a, 34b surround the interior structure of the electrical connector 10 used to make the necessary electrical contact with the cable or wire. The first cylindrical portion 34a includes one of the outer threaded portions 14a and inner threaded portions 16a. The second cylindrical portion 34b includes the other outer threaded portion 14b and inner threaded portion 16b and a threaded mounting portion 18. The respective diameters of the cylindrical portions 34a, 34b, as well as the outer threaded portions 14a, 14b, the inner threaded portions 16a, 16b, and the threaded mounting portion 18 are sized to allow the connection of electrical cable or wire connectors to each of the cylindrical portions 34a, 34b of the electrical connector 10 by threading the connector ends onto the cylindrical portions 34a, 34b.

The body 12 is constructed of a conductive material, preferably brass with tin plating. The internal structure of the electrical connector is that of any conventional electrical connector known in the art and may include a conductive center surrounded by an insulating jacket.

The body 12 and hexagonal flange 20 may be sized to be coordinated with the size of the wire or cable which are to be attached to the electrical connector 10. For example, if a conventionally sized coaxial cable, such as that used to distribute cable television or cable internet signals, is to be attached to the connector 10, the body 12 may have an overall length of approximately 1.025±0.010 inches and the cylindrical portions 34a, 34b may have an outer thread diameter of approximately 0.365±0.010 inches, while the hexagonal flange 20 may have a thickness of approximately 0.145±0.010 inches, a diameter of approximately 0.432±0.010 inches between opposing flats of the hexagon, and a diameter of approximately 0.490±0.010 inches between opposing corners of the hexagon. The outer threaded portions 14a, 14b and the inner threaded portions 16a, 16b may be of 3/8-32 UNEF-2A threading, although alternative threading may be used in conjunction with other sizes of electrical cable and corresponding end connectors. Further, the threaded mounting portion 18 may include the same threads as the outer and inner thread portions for consistency and ease of manufacturing.

The outer threaded portions 14a, 14b include threads 38a, 38b for mating with the interior threads 44a, 44b of the end connectors 42a, 42b of electrical cables or wires. Likewise, the inner threaded portions 16a, 16b include threads 40a, 40b for mating with the interior threads 44a, 44b of the end connectors 42a, 42b. The threads 38a, 38b of the outer threaded portions 14a, 14b and the threads 40a, 40b of the inner threaded portions 16a, 16b are circumferentially and axially aligned, so as to be continuous, such that interior threads 44a, 44b of end connectors 42a, 42b of electrical cables 48a, 48b may be fully attached to the outer threaded portions 14a, 14b and the inner threaded portions 16a, 16b without damaging the threads. That is, if the threads 38a, 38b of the outer threaded portions 14a, 14b and the threads 40a, 40b of the inner threaded portions 16a, 16b are offset around the circumference of the cylindrical portions 34a, 34b, the end connectors 42a, 42b of the electrical cables 48a, 48b can be prevented from or be difficult to fully threading into the electrical connector 10, because the interior threads 44a, 44b cannot thread onto the offset threads of the inner portions 16a, 16b after threading onto the outer threaded portions 14a, 14b. In any event, the threads of the end connector and/or the electrical connector may become damaged when the threads of the outer and inner threaded portions 14a, 14b, 16a, and 16b are offset, effecting the seal and securement of the cables and/or wire to the connector.

The body 12 preferably also includes the threaded mounting portion 18 that cooperates with a nut or other similar component to securely attach the electrical connector 10 to a supporting structure. For example, if it is desirable to ground the splice between two wires or cables, the electrical connector 10 may be connected to a grounding structure, such as a grounding connector, by extending the cylindrical portion 34b of the electrical connector 10 through an aperture in the grounding structure, with the hexagonal flange 20 on one side of the aperture and threading a nut, or other similar component, onto the threaded mounting portion 18 such that the nut is flush against the opposite side of the aperture. The threads 46 of the threaded mounting portion 18 are preferably circumferentially and axially aligned with the threads 38b of the outer threaded portion 14b and the threads 40b of the inner threaded portion 16b, to enable the nut to be threaded easily onto the threads 46 of the inner threaded portion 18 without damaging any of the threading on the electrical connector. However, the threaded mounting portion 18 may alternatively be omitted if such an ability to connect to a supporting or grounding structure is not necessary.

As illustrated in FIGS. 1-4, the first cylindrical portion 34a defines an outer annular groove 22a and an inner annular groove 24a. Likewise, the second cylindrical portion 34b defines an outer annular groove 22b and an inner annular groove 24b. The outer annular grooves 22a, 22b and inner grooves 24a, 24b preferable have a diameter which is less than that of the threaded portions 14a, 14b, 16a, 16b, and 18. For example, the outer grooves 22a, 22b and inner grooves 24a, 24b may have a diameter of approximately 0.30±0.010 inches. The outer grooves 22a, 22b and the inner grooves 24a, 24b may also be defined by unthreaded portions of the cylindrical portions 34a, 34b of the body 12.

The outer grooves 22a, 22b and the inner grooves 24a, 24b may have a variety of axial lengths. The outer grooves 22a, 22b should correspond with the width of the seal member. For example, where the electrical connector 10 is to be used with conventionally sized coaxial cable end connectors, the axial length of the outer grooves 22a, 22b may be approximately 0.075±0.010 inches. The inner grooves 24a, 24b should have an axial length that effectively deflects moisture and other foreign debris away from the sealed connection. For example, the grooves 24a, 24b may have the same axial length as the grooves 22a, 22b, but also may have differing axial lengths.

The outer groove 22a is located between the outer threaded portion 14a and the inner threaded portion 16a on a first side 28 of the connector 10. The outer groove 22b is located between the outer threaded portion 14b and the inner threaded portion 16b on a second side 26 of the connector 10.

Preferably, the outer grooves 22a, 22b are axially located such that the end connectors 42a, 42b of the electrical cables 48a, 48b extend beyond the outer grooves 22a, 22b when the end connectors 42a, 42b are threaded onto the electrical connector 10. The outer grooves 22a, 22b are axially located such that when the variation in the depth of the end connectors 42a, 42b of the electrical cables 48a, 48b is taken into account, the location of the outer grooves 22a, 22b is such that a variety of different end connectors extend partially over, or over and beyond, the outer grooves 22a, 22b. For example, if the electrical connector is to be used with conventionally sized coaxial cable end connectors the outer threaded portions 14a, 14b may have an axial length of approximately 0.165±0.010 inches and the outer grooves 22a, 22b may have an axial length of approximately 0.075±0.010 inches.

The inner grooves 24a, 24b preferably are located adjacent the inner threaded portions 16a, 16b. The inner groove 24a is located between inner threaded portion 16a and the hexagonal flange 20 on the side 28 of the connector 10. The inner groove 24b is located between inner threaded portion 16b and the threaded mounting portion 18, if the threaded mounting portion 18 is present on the electrical connector 10 (such as on the side 26 of the electrical connector 10 as shown in FIG. 2). As such, the inner groove 24b is located adjacent to both the inner threaded portion 16b and the threaded mounting portion 18. Preferably, the inner grooves 24a, 24b are axially located such that the end connectors 42a, 42b of the electrical cables 48a, 48b may be substantially aligned with outer edges 50a, 50b of the inner groove 24a, 24b when the end connectors 42a, 42b are threaded onto the electrical connector 10.

Preferably, the outer groves 22a, 22b and the inner grooves 24a, 24b are formed by taking an electrical connector having uninterrupted threads on each side and removing sections of threads in any way known in the art to form the outer groves 22a, 22b and the inner grooves 24a, 24b. Alternatively, the outer grooves 22a, 22b and the inner grooves 24a, 24b may be formed in the electrical connector 10 when the electrical connector 10 is initially manufactured.

Referring to FIG. 2, preferably the inner threaded portions 16a, 16b have an axial length that is less than that of the outer threaded portions 14a, 14b. Thus, it is preferable that the outer grooves 22a, 22b and the inner grooves 24a, 24b be in close proximity. For example, the axial length of the inner threaded portions 16a, 16b may be as little as a single thread or single revolution of a thread. However, the inner threaded portions 16a, 16b may also include multiple threads or a plurality of thread revolutions.

As illustrated in FIGS. 3-6, seal members, such as o-rings 32a, 32b, may be disposed within the outer grooves 22a, 22b of the body 12. The inner diameter and axial length of the o-rings 32a, 32b and the radial diameter and axial length of the outer grooves 22a, 22b preferably are coordinated, such that the o-rings 32a, 32b preferably fit snugly within the outer grooves 22a, 22b. The radial thickness of the o-rings 32a, 32b, or the outer diameter of the o-rings 32a, 32b, is sized such that the o-rings 32a, 32b are deformed by the interior threads 44a, 44b of the end connectors 42a, 42b that are connected to the electrical connector 10. For example, the o-rings 32a, 32b may have an outer diameter of 0.360±0.010 inches, an inner diameter of 0.280±0.005 inches, and an axial thickness of 0.063±0.010 inches before the o-rings 32a, 32b are stretched to be disposed in the outer grooves 22a, 22b. Alternatively, the o-rings 32a, 32b may be sized such that the o-rings 32a, 32b extend or project beyond the outer diameter of the threads 38a, 38b, 40a, and 40b, of the threaded portions 14a, 14b, 16a, and 16b of the electrical connector 10. Thus, the o-rings 32a, 32b are able to be deformed to form a seal between the cylindrical portions 34a, 34b and the interior threads 44a, 44b of the end connectors 42a, 42b of the electrical cables 48a, 48b.

The o-rings 32a, 32b preferably have a rectangular or square cross-section but, alternatively, may have a circular cross-section or any other cross-section known in the art. Preferably, the o-rings 32a, 32b are made of rubber and, more preferably, are made of a polyurethane material. The o-rings 32a, 32b, however, may be made of any material generally used in the construction of seals, such as silicone or plastic.

Although the electrical connector 10 illustrated in FIGS. 1-6 has sides 26, 28 which are asymmetric, the connector may also have sides which are symmetric about the hexagonal flange, or any other combination of side structures. For example, where only one side of the electrical connector will be exposed to the elements, the side which is protected from the elements may be that of a conventional electrical connector, while the opposite side, which is exposed to the elements, may have a seal and deflection groove. The side structure may also differ depending on the length of the different structural features, such as the axial lengths of the threaded portions and grooves.

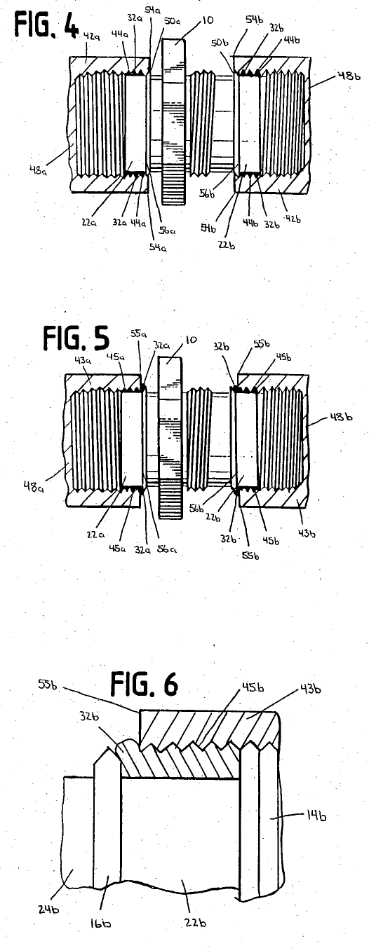

As illustrated in FIG. 4, in order to form an electrical connection in a manner that provides an environmentally sealed connection, the end connectors 42a, 42b of electrical cables 48a, 48b are threaded onto the electrical connector 10, with the interior threads 44a, 44b of the cables 48a, 48b threading onto the outer threaded portions 14a, 14b. As the end connectors 42a, 42b are threaded further onto the electrical connector 10, the interior threads 44a, 44b come into contact with the o-rings 32a, 32b disposed in the outer grooves 22a, 22b. Generally, the interior threads 44a, 44b cause the outer surfaces 52a, 52b of the o-rings 32a, 32b to deform around the threads 44a, 44b and expand axially in the outer grooves 22a, 22b and form a seal between the electrical connector 10 and the end connectors 42a, 42b.

The end connectors 42a, 42b are further threaded onto the electrical connector 10, until the leading edges 54a, 54b of the end connectors 42a, 42b extend beyond the inner edges 56a, 56b of the outer grooves 22a, 22b. The interior threads 44a, 44b of the end connectors 42a, 42b of the electrical cables 48a, 48b then are brought into contact with, or are threaded onto, the inner threaded portions 16a, 16b as the end connectors 42a, 42b are further threaded onto the electrical connector 10. The end connectors 42a, 42b of the cables 48a, 48b are threaded onto the electrical connector 10 until the end connectors 42a, 42b are fully threaded onto the connector 10.

Preferably, the leading edges 54a, 54b of the end connectors 42a, 42b extend at least slightly beyond the outer edges 50a, 50b of the inner grooves 24a, 24b when the end connectors 42a, 42b are fully threaded onto the electrical connector 10. Alternatively, the leading edges 54a, 54b may extend beyond the outer edges 50a, 50b at a point before the end connectors 42a, 42b are fully threaded onto the electrical connector 10. Thus, the connection of the end connectors 42a, 42b to the electrical connector 10 forms an environmental seal between the connector 10 and the end connectors 42a, 42b of the cables 48a, 48b, substantially preventing the migration of moisture and other debris into the interior of the cables 48a, 48b and into the cable/connector interface. The inner grooves 24a, 24b and the inner threaded portions 16a, 16b further aid this process by causing moisture and other debris to migrate away from the outer grooves 22a, 22b and the o-rings 32. That is, the inner grooves 24a, 24b may deflect foreign matter away from the inner grooves 22a, 22b and the o-rings 32a, 32b.

An alternative method of making a seal with the o-ring 32a, 32b, which is used with end connectors 43a, 43b which do not extend beyond the outer groove 22a, 22b, is illustrated in FIGS. 5-6. In order to form an electrical connection in such a case, the end connectors 43a, 43b of electrical cables 48a, 48b are threaded onto the electrical connector 10, with the interior threads 45a, 45b of the cables 48a, 48b threading onto the outer threaded portions 14a, 1413. As the end connectors 43a, 43b are threaded further onto the electrical connector 10, the interior threads 45a, 45b come into contact with the o-rings 32a, 32b disposed in the outer grooves 22a, 22b. Generally, the interior threads 45a, 45b cause the outer surfaces 52a, 52b of the o-rings 32a, 32b to deform around the threads 45a, 45b and expand axially in the outer grooves 22a, 22b and form a seal between the electrical connector 10 and the end connectors 43a, 43b. Additionally, as the end connectors 43a, 43b are threaded onto the electrical connector 10, the end connectors 43a, 43b causes the o-rings 32a, 32b to bunch up or bulge just ahead of the end connectors 43a, 43b due to the axial expansion of the o-rings 32a, 32b and the axial movement of the end connectors 43a, 43b as the end connectors 43a, 43b are threaded onto the electrical connector 10. In a preferred situation, this bulging of the o-rings 32a, 32b ensures that the o-rings 32a, 32b have expanded into and around the structure at this connection to provide an enhanced seal.

The end connectors 43a, 43b are further threaded onto the electrical connector 10, until the end connectors 43a, 43b are fully threaded onto the connector 10. Since the end connectors 43a, 43b are not long enough to extend fully over the outer grooves 22a, 22b, when the end connectors 43a, 43b are fully connected to the electrical connector 10, the leading edges 55a, 55b of the end connectors 43a, 43b fall somewhere within the outer grooves 22a, 22b, generally close to the inner edges 56a, 56b of the outer grooves 22a, 22b. However, unlike the connection shown in FIG. 4, there is a small gap between the leading edges 55a, 55b of the end connectors 43a, 43b and the inner threaded portions 16a, 16b.

Despite this small gap, and due to the bunching up or bulging of the o-rings 32a, 32b ahead of the leading edges 55a, 55b of the end connectors 43a, 43b, the o-rings 32a, 32b form slight bulges between the leading edges 55a, 55b of the end connectors 43a, 43b and the inner threaded portions 16a, 16b and form a seal between the leading edges 55a, 55b of the end connectors 43a, 43b and the inner threaded portions 16a, 16b Thus, the connection of the end connectors 43a, 43b to the electrical connector 10 forms an environmental seal between the connector 10 and the end connectors 43a, 43b of the cables 48a, 48b, substantially preventing the migration of moisture and other debris into the interior of the cables 48a, 48b and into the cable/connector interface, even when the end connectors 43a, 43b do not fully extend over the outer grooves 22a, 22b. The inner grooves 24a, 24b and the inner threaded portions 16a, 16b further aid this process by causing moisture and other debris to migrate away from the outer grooves 22a, 22b and the o-rings 32. That is, the inner grooves 24a, 24b may deflect foreign matter away from the inner grooves 22a, 22b and the o-rings 32a, 32b.

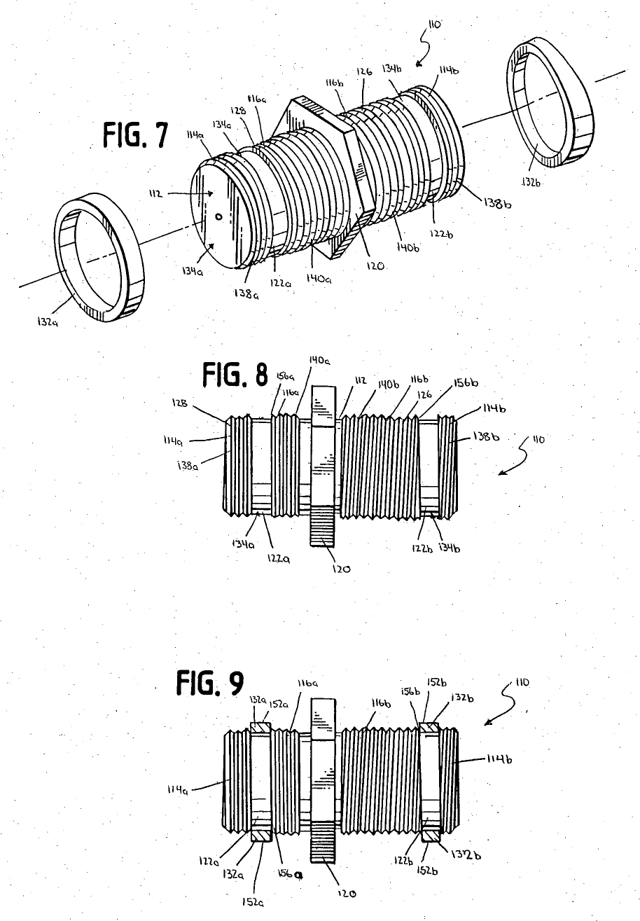

Referring to FIGS. 7-10, there is illustrated an electrical connector 110 having a body 112. The body 112 includes outer threaded portions 114a, 114b and inner threaded portions 116a, 116b, which are separated by grooves 122a, 122b, respectively. Seal members, such as o-rings 132a, 132b, are disposed in the grooves 122a, 122b. When end connectors 142a, 142b of electrical cables 148a, 148b or wires are connected to the electrical connector 110, interior threads 144a, 144b of the end connectors 142a, 142b cover and deform the seal members, which, in turn, creates a seal between the electrical connector 110 and the end connectors 142a, 142b. The grooves 122a, 122b and the seal members 132a, 132b are axially located such that the electrical connector 110 universally seals between the electrical connector 110 and the end connectors 142a, 142b of electrical cables or wires, regardless of the axial length of the end connectors 142a, 142b. Thus, the electrical connector 110 effectively seals the interface between the connector and the end connectors of electrical cables, such that moisture and other debris are deterred from migrating into the interior of the cable.

The body 112 includes a hexagonal flange 120 separating a first cylindrical portion 134a and a second cylindrical portion 134b. The two cylindrical portions 134a, 134b surround the interior structure of the electrical connector 10. The first cylindrical portion 134a includes one of the outer threaded portions 114a and one of the inner threaded portions 116a. The second cylindrical portion 134b includes the other outer threaded portion 114b and the other inner threaded portions 116b. The respective diameters of the cylindrical portion 134a, 134b, as well as the outer threaded portions 114a, 114b and the inner threaded portions 116a, 116b, are sized to allow the connection of electrical cable or wire connectors to each of the cylindrical portions 134a, 134b.

The body 112 is constructed of a conductive material, preferably brass with tin plating. The internal structure of the electrical connector is that of any conventional electrical connector known in the art and may include a conductive center surrounded by an insulating jacket.

The body 112 and the hexagonal flange 120 may be sized to compliment the size of the wires or cables which are to be attached to the electrical connector 110. For example, if a conventionally sized coaxial cable, such as that used to distribute cable television or cable internet signals, is to be attached to the connector 110, the body 112 may have an overall axial length of approximately 1.025±0.010 inches, and the cylindrical portions 134a, 134b may have an outer thread diameter of approximately 0.365±0.010 inches, while the hexagonal flange 20 may have a thickness of approximately 0.145±0.010 inches, a diameter of approximately 0.432±0.010 inches between opposing flats of the hexagon, and a diameter of approximately 0.490±0.010 inches between opposing corners of the hexagon.

More specifically, the cylindrical portions 134a, 134b include the outer threaded portion 114a, 114b and the inner threaded portions 116a, 116b, respectively, which are sized to receive end connectors 142a, 142b of electrical cables 148a, 148b. For example, the outer threaded portions 114a, 114b and the inner threaded portions 116a, 116b may be of 3/8-32 UNEF-2A threading, although alternative threading sizes may be used depending on other sizes of electrical cable and wires and the corresponding end connectors for such.

The outer threaded portions 114a, 114b include threads 138a, 138b, respectively, for receiving the interior threads 144a, 144b of the end connectors 142a, 142b of electrical cables or wires. Likewise, the inner threaded portions 116a, 116b include threads 140a, 140b for receiving the interior threads 144a, 144b of the end connectors 142a, 142b. The threads 138a, 138b of the outer threaded portions 114a, 114b and the threads 140a, 140b of the inner threaded portions 116a, 116b are circumferentially and axially aligned, so as to be continuous, such that interior threads 144a, 144b of end connectors 142a, 142b of electrical cables 148a, 148b may be fully attached to the outer threaded portions 114a, 114b and the inner threaded portions 116a, 116b. That is, if the threads 138a, 138b of the outer threaded portions 114a, 114b and the threads 140a, 140b of the inner threaded portions 116a, 116b are offset around the circumference of the cylindrical portions 134a, 134b, the end connectors 142a, 142b of the electrical cables 148a, 148b are deterred and, in some cases, prevented from fully threading into the electrical connector 110 because the interior threads 144a, 144b cannot thread smoothly, if it all, onto the offset threads of the inner threaded portions 116a, 116b after threading onto the outer threaded portions 114a, 114b. In any event, when the threads of the outer and inner threaded portions 114a, 114b, 116a, and 116b are offset, the threading of both the electrical connector 110 and the end connectors 142a, 142b is likely to be damaged by forcing the end connectors 142a, 142b onto the inner threaded portions 116a, 116b of the electrical connector 110.

The threads 140a, 140b of the inner threaded portions 116a, 116b preferably also enable the electrical connector 110 to be attached to a supporting structure. For example, if it is desirable to ground the splice between two wire or cables, the electrical connector 110 may be connected to a grounding structure, such as a grounding connector, by extending the cylindrical portion 134b of the electrical connector 10 through an aperture in the grounding structure with the hexagonal flange 120 on one side of the aperture and threading a nut, or other similar component, onto the opposite inner threaded portion 116b such that the nut can be tightened flush against the opposite side of the aperture. The threads 140b of the inner threaded portion 116b may extend into close proximity to, or adjacent to, the hexagonal flange 120 on one side 126 of the connector 10 in order to receive a nut, or similar component, when the electrical connector 110 is attached to a supporting or grounding structure. However, the inner threaded portions 116a, 116b need not be designed to receive a nut if such an ability to connect to a supporting or grounding structure is not necessary.

The first cylindrical portion 134a preferably defines a first groove 122a and the second cylindrical portion 134b defines a second groove 122b. The grooves 122a, 122b preferably have a diameter which is less than that of the threaded portions 114a, 114b, 116a, and 116b of the electrical connector 110. For example, the grooves 122a, 122b may have a diameter of approximately 0.30±0.010 inches. Alternatively, the cylindrical portions 134a, 134b may define unthreaded portions of the body 112 having a diameter less than the threaded portions 114a, 114b, 116a, and 116b of the electrical connector 110. The grooves 122a, 122b may have a variety of axial lengths. It is preferred that the axial length of the grooves 122a, 122b corresponds with the axial length of the seal members. For example, where the electrical connector is to be used with a conventional sized coaxial cable and end connector, the axial length of the grooves 122a, 122b is preferably approximately 0.075±0.010 inches. The grooves 122a, 122b preferably have the same axial length such that seal members of a single size may be disposed in the grooves 122a, 122b. The grooves 122a, 122b, however, may have different axial lengths if such a difference is desireable.

The groove 122a is located between the outer threaded portion 114a and the inner threaded portion 116a on one side 128 of the electrical connector 110. Similarly, the groove 122b is located between the outer threaded portion 114b and the inner threaded portion 116b on an opposite side 126 of the electrical connector 110.

Preferably, the grooves 122a, 122b are axially located such that the end connectors 142a, 142b of the electrical cables 148a, 148b may extend over and beyond the grooves 122a, 122b, respectively, and be threaded onto the inner threaded portions 116a, 116b when threaded onto the electrical connector 110. The grooves 122a, 122b are axially located such that the variation in axial length of end connectors of the electrical cables is taken into account. That is, the location of the grooves 122a, 122b is such that end connectors of a range of different axial lengths extend over and beyond the grooves 122a, 122b and thread onto the inner threaded portions 116a, 116b. For example, if the electrical connector is to be used with a conventional sized coaxial cable end connectors, the outer threaded portions 114a, 114b may have an axial length of approximately 0.125±0.010 inches, and the grooves 122a, 122b may have an axial length of approximately 0.075±0.010 inches.

The grooves 122a, 122b preferably are formed by taking an electrical connector having uninterrupted threads on each side and removing a section of threads in any way known in the art in order to form the groves 122a, 122b. Alternatively, the grooves 122a, 122b may be formed in the electrical connector 110 when the electrical connector 110 is initially manufactured.

Preferably, the inner threaded portion 116a has an axial length that is generally the same as the axial length of the outer threaded portion 114a, and the inner threaded portion 116b has an axial length which is greater than the axial length of the outer threaded portion 114b. Alternatively, the inner threaded portions 116a, 116b may have an axial length that is smaller than that of the outer threaded portions 114a, 144b. For example, the axial length of the inner threaded portions 116a, 116b may be as little as a single thread or single revolution of a thread. However, the axial length of the inner threaded portions 116a, 116b must have sufficient threading or revolutions of threads to allow the end connectors 142a, 142b of the cable 148a, 148b to be effectively threaded onto the inner threaded portions 116a, 116b.

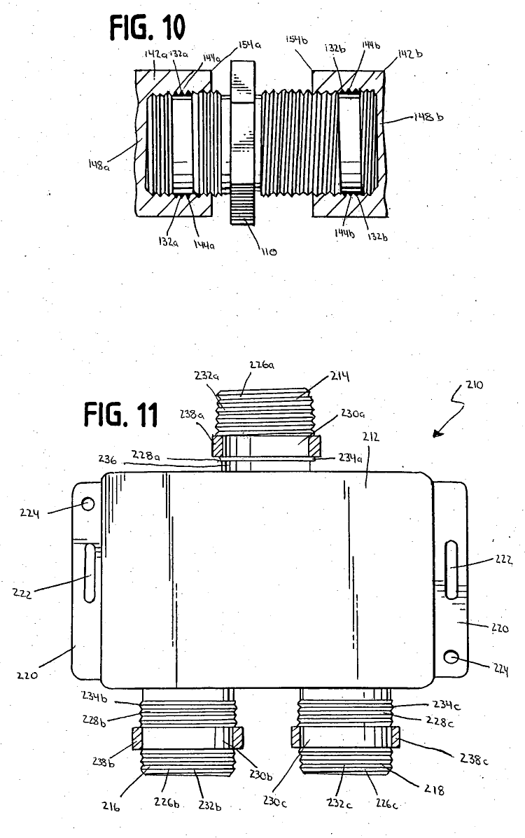

As illustrated in FIGS. 9 and 10, seal members, such as o-rings 132a, 132b, are disposed within the grooves 122a, 122b of the body 112. The inner diameter and axial length of the o-rings 132a, 132b and the radial depth and axial length of the grooves 122a, 122b preferably are sized such that the o-rings 132a, 132b fit snugly within the grooves 122a, 122b. The radial thickness of the o-rings 132a, 132b, or the outer diameter of the o-rings 132a, 132b, is sized such that the o-rings 132a, 132b are deformed by the interior threads 144a, 144b of the end connectors 142a, 142b that are connected to the electrical connector 110. For example, the o-rings 132a, 132b may have an outer diameter of 0.360±0.010 inches, an inner diameter of 0.280±0.005 inches, and an axial thickness of 0.063±0.010 inches before the o-rings 132a, 132b are stretched to be disposed in the grooves 122a, 122b. Alternatively, the o-rings 132a, 132b may be sized such that the o-rings 132a, 132b extend or project beyond the outer diameter of the threads 138a, 138b, 140a, and 140b, of the threaded portions 114a, 114b, 116a, and 116b of the electrical connector 110. Thus, the o-rings 132a, 132b are able to be deformed to form an effective seal between the cylindrical portions 134a, 134b and the interior threads 144a, 144b of the end connectors 142a, 142b of the electrical cables 148a, 148b.

The o-rings 132a, 132b preferably have a rectangular or square cross-section, but the o-rings 132a, 132b alternatively may have a circular cross-section or any other cross-section known in the art. Preferably, the o-ings 132a, 132b are made of rubber and, more preferably, are made of a polyurethane material. The o-rings 132a, 132b, however, maybe made of any material generally used in the construction of seals, such as silicone or plastics.

Although the connector 110 illustrated herein has sides 126, 128 which are asymmetric, the connector 110 also may have sides which are symmetric about the hexagonal flange or any other combination of side structures. For example, where only one side of the electrical connector will be exposed to the elements, the side which is protected from the elements may be that of a conventional electrical connector, while the opposite side, which is exposed to the elements, may be that of the electrical connector 110 illustrated herein. The side structures may also differ based on the axial length of the different features, such as the axial length of the threaded portions and grooves.

As illustrated in FIG. 10, in order to form an electrical connection in a manner that provides an environmentally sealed connection, the end connectors 142a, 142b of the electrical cables 148a, 148b are threaded onto the electrical connector 110, with the interior threads 144a, 144b of the end connector 142a, 142b threading onto the outer threaded portions 114a, 114b. As the end connectors 142a, 142b are threaded further onto the electrical connector 110, the interior threads 144a, 144b come into contact with the o-rings 132a, 132b. Generally, the interior threads 144a, 144b cause the outer surfaces 152a, 152b of the o-rings 132a, 132b to deform around the threads 144a, 144b and the o-rings 132a, 132b to expand in the grooves 122a, 122b. This deformation and expansion forms an effective seal between the electrical connector 110 and the end connectors 142a, 142b.

The end connectors 142a, 142b are further threaded onto the inner threaded portions 116a, 116b of the electrical connector 110. The end connectors 142a, 142b are further threaded onto the electrical connector 110 until the end connectors 142a, 142b have been fully threaded onto the connector 110, at which point leading edges 154a, 154b of the end connectors 142a, 142b preferably extend beyond the inner edges 156a, 156b of the grooves 122a, 122b, such that the leading edges 154a, 154b fall generally within the inner threaded portions 116a, 116b and the grooves 122a, 122b and the o-rings 132a, 132b are axially displaced away from the leading edges 154a, 154b.

Preferably, the grooves 122a, 122b and the o-rings 132a, 132b are located in the interior of the end connectors 142a, 142b of the electrical cables 148a, 148b when the end connectors 142a, 142b are fully threaded onto the electrical connector 110, such that the interior threads 144a, 144b of the end connectors 142a, 142b are threaded onto both the outer threaded portions 114a, 114b and the inner threaded portions 116a, 116b. Thus, the connection of the end connectors 142a, 142b to the electrical connector 110 forms an environmental seal between the connector 110 and the end connectors 142a, 142b of the cables 148a, 148b, preventing and/or substantially deterring the migration of moisture and other debris into the interior of the cables 148a, 148b and into the cable/connector interface. The threads 140a, 140b of the inner threaded portions 116a, 116b further aid this process by causing moisture and other debris to migrate away from the grooves 122a, 122b and the o-rings 132a, 132b, much like the inner grooves 24a, 24b and the inner threaded portion 16a, 16b of the electrical connector 10 discussed above. That is, the threads 140a, 140b of the inner threaded portions 116a, 116b may deflect foreign matter away from the grooves 122a, 122b and the o-rings 132a, 132b.

While the electrical connectors illustrated in FIGS. 1-10 are shown to be of the type used in the splicing of two electrical cables, other types of electrical connectors and components having a threaded connector may also be designed to include objects of the present invention. Such connectors and components may include, but are not limited to, “F” connectors and “F” jacks for coaxial cables, in-line splicing hardware, digital splitters, splitters, ground blocks, signal amplifiers, directional couplers, angled adapters, terminators, wall plates, reducer/adapters, couplers, combiners, cable surge protectors, satellite/TV antenna diplexers, and converters.

For example, FIG. 11 illustrates a splitter 210 having a body 212. The body 212 surrounds any internal structure for splitting cable or electrical signals. The body 212 includes a first cylindrical portion 214, a second cylindrical portion 216, and a third cylindrical portion 218. Preferably, the first cylindrical portion 214 is located opposite the second cylindrical portion 216 and the third cylindrical portion 218. However, the cylindrical portions 214, 216, and 218 may alternatively have any configuration known in the art. For example, the second cylindrical portion 216 may be located opposite the third cylindrical portion 218, and the second and third cylindrical portions 216, 218 may be located along an axis perpendicular to that of the first cylindrical portion 214.

Preferably, the first cylindrical portion 214 may act as an input for the electrical signal, and the second cylindrical portion 216 and the third cylindrical portion 218 may act as the two outputs for the electrical signal. However, any of the three cylindrical portions 214, 216, and 218 may act as the input and the remaining two cylindrical portions may act as the outputs.

The body 212 of the splitter 210 may optionally include attachment portions or flanges 220. The attachment portions 220 may include attachment apertures 222 for receiving a fastener to attach the splitter 210 to a preexisting structure, such as a wall, ceiling, floor, or other suitable structure. The attachment portions 220 may also include apertures 224 for receiving fasteners for securing a grounding wire to the splitter 210. Alternatively, the body 212 may include a structure for securing a grounding wire to the splitter 210. While the attachment portions 220 may preferably be included in most cases, the attachment portions 220 may also be omitted from the splitter 210. The body 212 is constructed of a conductive material, preferably brass with tin plating.

The first cylindrical portion 214 includes an outer threaded portion 226a and an inner threaded portion 228a, which are separated by a groove 230a. The groove 230a preferably has a diameter which is less than that of the threaded portions 226a and 228a. The groove 230a may also be defined by an unthreaded portion of the first cylindrical portion 214. Preferably, the groove 230a is axially located such that the leading edge of the end connector of the electrical cable extends at least into the groove 230a and in some cases beyond the groove 230a when the end connector is threaded onto the first cylindrical portion 214. More specifically, for example, the groove 230a may be axially located such that when the variation in the depth of different end connectors is taken into account, the location of the groove 230a is such that a variety of different end connectors extend at least partially over, or over and beyond, the groove 230a. The groove 230a may be formed by taking a splitter having uninterrupted threads on the first cylindrical portion 214 and removing a section of the threads in any way known in the art to form the groove 230a.

Preferably, the inner threaded portion 228a of the first cylindrical portion 214 has an axial length that is less than that of the outer threaded portion 226a. For example, the axial length of the inner threaded portion 228a may be as short as a single thread or single revolution of a thread. However, the inner threaded portion 228a may also include multiple threads or a plurality of thread revolutions.

Optionally, the first cylindrical portion 214 may include an inner groove 236 located between the body 212 of the splitter 210 and the inner threaded portion 228a of the first cylindrical portion 214. If the inner groove 236 is used in connection with any of the cylindrical portions, such as the first cylindrical portion 214, the inner groove 236 should have an axial length that effectively deflects moisture and other foreign debris away from the sealed connection. Optionally, the first cylindrical portion 214 may include a threaded mounting portion adjacent the body 212 of the splitter 210 for attaching the splitter to a structure, such as a grounding connector.

The second cylindrical portion 216 includes an outer threaded portion 226b and an inner threaded portion 228b, which are separated by a groove 230b. Likewise, the third cylindrical portion 218 includes an outer threaded portion 226c and an inner threaded portion 228c, which are separated by a groove 230c. The grooves 230b, 230c preferably have diameters which are less than that of the threaded portions 226b, 226c, 228b, and 228c. The grooves 230b, 230c may also be defined by unthreaded portions of the second cylindrical portion 216 and third cylindrical portion 218, respectively. Preferably, the grooves 230b, 230c are axially located such that the leading edges of the end connectors of the electrical cables extend at least over the grooves 230b, 230c and, in some instances, beyond the grooves 230b, 230c and thread onto the inner threaded portions 228b and 228c when the end connectors are threaded onto the second cylindrical portion 216 and third cylindrical portion 218, respectively. More specifically, for example, the grooves 230b, 230c are axially located such that when the variation in the depth of the end connectors is taken into account, the location of the grooves 230b, 230c are such that a variety of different end connectors extend at least over, or over and beyond, the grooves 230b, 230c. The grooves 230b, 230c may be formed by taking a splitter having uninterrupted threads on the second and third cylindrical portions 216 and 218 and removing a section of the threads in any way known in the art to form the grooves 230b, 230c.

Preferably, the inner threaded portions 228b, 228c of the cylindrical portions 216, 218 have axial lengths that are generally the same as the axial length of the outer threaded portions 226b, 226c. Alternatively, the axial length of the inner threaded portions 228b, 228c may be smaller than that of the outer threaded portions 226b, 226c. For example, the axial length of the inner threaded portions 228b, 228c may be as little as a single thread or single revolution of a thread. However, the axial length of the inner threaded portions 228b, 228c should have sufficient threading or revolutions of threads to allow the end connectors of electrical cables to be effectively threaded onto the inner threaded portions 228b, 228c if desired.

The respective diameters of the cylindrical portions 214, 216, and 218, as well as the outer threaded portions 226a, 226b, and 226c and the inner threaded portions 228a, 228b, and 228c, are sized to allow the connection of electrical cable or wire connectors to each of the cylindrical portions 214, 216, and 218 by threading the connector ends onto the cylindrical portions 214, 216, and 218.

The outer threaded portions 226a, 226b, and 226c include threads 232a, 232b, and 232c for mating with the interior threads of end connectors of electrical cables or wires. Likewise, the inner threaded portions 228a, 228b, and 228c include threads 234a, 234b, and 234c for mating with the interior threads of end connectors. The threads 232a, 232b, and 232c of the outer threaded portions 226a, 226b, and 226c and the threads 234a, 234b, and 234c of the inner threaded portions 228a, 228b, and 228c are circumferentially and axially aligned, so as to be continuous, such that the interior threads of the end connectors of the electrical cables may be fully attached to the outer threaded portions 226a, 226b, and 226c and the inner threaded portions 228a, 228b, and 228c without damaging the threads. That is, the threads of the end connector and/or the splitter may become damaged when the threads of the outer and inner threaded portions 226a, 226b, 226c, 228a, 228b, and 228c are offset, effecting the seal and securement of the cables and/or wire to the splitter.

Seal members, such as o-rings 238a, 238b, and 238c, are disposed in the grooves 230a, 230b, and 230c. The inner diameter and axial length of the o-rings 238a, 238b, and 238c and the radial diameter and axial length of the grooves 230a, 230b, and 230c preferably are coordinated, such that the o-rings 238a, 238b, and 238c fit snugly within the grooves 230a, 230b, and 230c. The radial thickness of the o-rings 238a, 238b, and 238c or the outer diameter of the o-rings 238a, 238b, and 238c is sized such that the o-rings 238a, 238b, and 238c are deformed by the interior threads of the end connectors that are connected to the splitter 210. Thus, the o-rings 238a, 238b, and 238c are able to be deformed to form a seal between the cylindrical portions 214, 216, and 218 and the interior threads of the end connectors of the electrical cables.

The o-rings 238a, 238b, and 238c preferably have a rectangular or square cross-section but, alternatively, may have a circular cross-section or any other cross-section. Preferably, the o-rings 238a, 238b, and 238c are made of rubber and, more preferably, are made of a polyurethane material. The o-rings 238a, 238b, and 238c, however, may be made of any material generally known and used in the construction of seals, such as silicone or plastic.

Although the cylindrical portions 214, 216, and 218 of the splitter 210 illustrated in FIG. 11 are asymmetric with respect to the body 212 of the splitter 210, with the structure of the first cylindrical portion 214 being different than that of the second and third cylindrical portions 216 and 218, the splitter 210 may also have cylindrical portions which each have different structures from each other, each have the same structure, or any other combination thereof. For example, where only one cylindrical portion of the splitter will be exposed to moisture and foreign debris, the cylindrical portion(s) protected from the moisture and foreign debris may be that of a conventional electrical connector, while the cylindrical portions(s) on the opposite side, which is exposed to the moisture and foreign debris, may have a seal and deflection groove. The cylindrical portions may also differ depending on the length of the different structural features, such as the axial lengths of the threaded portions and grooves and the corresponding connectors on the ends of cables and wires.

In order to form an environmental seal, the end connectors of the electrical cables are threaded onto the cylindrical portions 214, 216, and 218 of the splitter 210, with the interior threads of the end connectors threading onto the outer threaded portions 226a, 226b, and 226c. As the end connectors are threaded further onto the splitter 210, the interior threads come into contact with the o-rings 238a, 238, and 238c disposed in the grooves 230a, 230b, and 230c. The interior threads cause the outer surfaces of the o-rings 230a, 230b, and 230c to deform around the threads and expand axially in the grooves 230a, 230b, and 230c and form a seal between the splitter 210 and the end connectors.

The end connectors are further threaded onto the cylindrical portions 214, 216, and 218 until the end connectors are fully threaded onto the cylindrical portions 214, 216, and 218. In the case of the first cylindrical portion 214, the leading edge of the end connector preferably extends slightly beyond the outer edge of the inner groove 236. In the case of the second and third cylindrical portions 216 and 218, the end connector preferably partially threads onto the inner threaded portions 228b and 228c. Thus, the connection of the end connectors to the splitter 210 forms an environmental seal between the splitter 210 and the end connectors of electrical cables, substantially preventing or deterring the migration of moisture and other debris into the interior of the cables and into the cable/splitter interface. The inner groove 236, if included, and the threads 234a, 234b, and 234c further aid in this process by deflecting moisture and other foreign debris away from the grooves 230a, 230b, and 230c and the o-rings 238a, 238b, and 238c. Alternatively, the end connectors could be sized to cause the sealing bulge discussed above with respect to FIGS. 5 and 6.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An electrical connection comprising:
a first threaded portion for attachment to a cable connector;
a second threaded portion for attachment to the cable connector; a groove located between the first threaded portion and the second threaded portion; and
an o-ring disposed in the groove, wherein the o-ring has a cross-section sized such that the o-ring seals an interface at the electrical connection when the cable connector threadably engages the first threaded portion and the second threaded portion.
